(19) United States
(12) Patent Application Publication
(10) Pub. No.: US 2024/0119335 A1
(43) Pub. Date: Apr. 11, 2024

(54) QUANTUM CHIP, QUANTUM COMPUTER, AND FABRICATION METHOD FOR QUANTUM CHIP

(71) Applicant: Origin Quantum Computing Technology (Hefei) Co., Ltd, Hefei (CN)

(72) Inventors: Hui YANG, Hefei (CN); Ye LI, Hefei (CN)

(73) Assignee: Origin Quantum Computing Technology (Hefei) Co., Ltd, Hefei (CN)

(21) Appl. No.: 18/390,335

(22) Filed: Dec. 20, 2023

Related U.S. Application Data
(63) Continuation of application No. PCT/CN2022/105659, filed on Jul. 14, 2022.

(30) Foreign Application Priority Data
Jul. 14, 2021 (CN) 202110803811.5

(51) Int. Cl. G06N 10/40

(52) U.S. Cl. CPC G06N 10/40

(57) ABSTRACT

Disclosed are a quantum chip, a quantum computer, and a fabrication method for a quantum chip. The quantum chip includes a substrate and an adapter plate, at least one qubit is formed on the substrate, signal transmission lines are formed on the adapter plate, and the signal transmission lines are electrically connected to the at least one qubit.

### CROSS-REFERENCE TO RELATED APPLICATIONS

This application is a continuation of International Application No. PCT/CN2022/105659, filed on Jul. 14, 2022, which claims priority to Chinese Patent Application No. CN202110803811.5, entitled “QUANTUM CHIP, QUANTUM COMPUTER, AND FABRICATION METHOD FOR QUANTUM CHIP”, filed on Jul. 14, 2021. The disclosures of the aforementioned applications are hereby incorporated by reference in their entireties.

### TECHNICAL FIELD

The present application pertains to the field of quantum technologies, and in particular, to a quantum chip, a quantum computer, and a fabrication method for a quantum chip.

### BACKGROUND

Quantum computers are physical apparatuses that perform high-speed mathematical and logical operations as well as store and process quantum information in accordance with the laws of quantum mechanics. The quantum computers mainly have advantages of high running speed, strong information handling capability, wide application range and the like. Compared with general computers, the larger the information processing amount of the quantum computers, the more advantageous for the quantum computers to implement an operation, and the more accurate the operation can be ensured. For the quantum computers, the greater the quantity of qubits located on a quantum chip, the stronger the ability to execute quantum computing.

Currently, a quantum chip of a superconducting system generally uses a method of forming structures such as a qubit, a read cavity, a microwave line, and ports thereof on one substrate. With an increase of a requirement for a computing capability of the quantum computers, a requirement for a large quantity of qubit become more and more urgent. However, in the foregoing manner, it is difficult to implement expansion of a large quantity of qubits. For high-speed development of quantum chips in the quantum field, a technical problem of how to expand a large quantity of qubits on a substrate of a quantum chip needs to be urgently solved.

It should be noted that, the information disclosed in background of the present application is merely intended to make deeper understanding of the general background of the present application, and should not be considered as acknowledgement or any form of implication that the information constitutes a conventional technology known to a person skilled in the art.

### SUMMARY

An objective of the embodiments of the present application is to provide a new quantum chip, quantum computer, and fabrication method of a quantum chip, which specifically include the following contents.

A quantum chip according to an embodiment includes a substrate, where at least one qubit is formed on the substrate; and an adapter plate, where signal transmission lines are formed on the adapter plate, and the signal transmission lines are electrically connected to the qubit.

Further, a readout signal port, an XY signal port, and a Z signal port are further formed on the substrate. The qubit is connected to signal transmission lines through the readout signal port, the XY signal port, and the Z signal port.

Further, a microwave resonant cavity coupled to a qubit in a one-to-one correspondence manner is further formed on the substrate, and the readout signal port is coupled to the microwave resonant cavity.

Further, a quantity of readout signal ports is the same as a quantity of qubits, and the readout signal ports are coupled to the at least one qubit in a one-to-one correspondence manner.

Further, the signal transmission lines include a readout signal line electrically connected to the readout signal port, an XY signal control line electrically connected to the XY signal port, and a Z signal control line electrically connected to the Z signal port.

Further, an indium pillar for implementing electrical connection is formed between the readout signal port and the readout signal line, between the XY signal port and the XY signal control line, and between the Z signal port and the Z signal control line.

Further, the readout signal line has a first transmission port, the XY signal control line has a second transmission port, and the Z signal control line has a third transmission port.

Further, the readout signal line, the XY signal control line, the Z signal control line, the first transmission port, the second transmission port, and the third transmission port are located on a same surface of the adapter plate.

Further, the readout signal line, the XY signal control line, and the Z signal control line are located on a first surface of the adapter plate, the first transmission port, the second transmission port, and the third transmission port are located on a second surface of the adapter plate.

Further, a plurality of through holes are formed on the adapter plate, and a superconductor is disposed in each of the through holes. A through hole is provided at each of the first transmission port, the second transmission port, and the third transmission port. The readout signal line, the XY signal control line, and the Z signal control line are in a one-to-one correspondence with and connected by using a superconductor to the first transmission port, the second transmission port, and the third transmission port, respectively.

Further, the substrate is disposed on the adapter plate, and the adapter plate is installed on an external printed circuit board (PCB) in a flip-chip bonding manner or a wire bonding manner.

Further, the XY signal port is connected to the qubit through capacitive coupling.

Further, the Z signal port is connected to the qubit through inductive coupling.

An embodiment of the present application further provides a quantum computer, and the quantum computer includes the foregoing quantum chip.

An embodiment of the present application further provides a fabrication method of a quantum chip, including: providing a substrate, where at least one qubit is formed on the substrate; and further providing an adapter plate, where signal transmission lines are formed on the adapter plate, and the signal transmission lines are electrically connected to the qubit.

Compared with the conventional technology, effects of the embodiments are as follows.

Firstly, as a quantity of qubits increases, if structures such as a qubit, a readout signal line, an XY signal control line, and a Z signal control line are integrated into one substrate in a conventional manner, it is difficult to implement fabrication of large-scale qubits. In different embodiments, a large quantity of signal transmission lines that occupy an area of the substrate are independently arranged, an adapter plate is disposed, signal transmission lines such as a readout signal line, an XY signal control line, and a Z signal control line are disposed on the adapter plate, and only a readout signal port, an XY signal port, and a Z signal port that are correspondingly connected to a qubit are fabricated on the substrate. The readout signal port, the XY signal port, and the Z signal port are respectively connected to the readout signal line, the XY signal control line, and the Z signal control line. In this way, more space is reserved on the substrate for fabrication of qubits, thereby greatly reducing an occupation area on the substrate. Therefore, more qubits can be fabricated on a substrate of a same area, improving integration.

Secondly, signal transmission lines are disposed on an adapter plate and are separated from a substrate. During packaging, the signal transmission lines are distributed on the adapter plate in a diffusion manner, and not concentrated on the substrate, facilitating an electrical connection between the signal transmission lines and an external PCB.

Thirdly, in an embodiment, a quantum computer is further provided, which has all beneficial effects brought by the foregoing quantum chip.

Lastly, in an embodiment, a fabrication method for a quantum chip is further provided. The quantum chip fabricated by using this method has the foregoing beneficial effects.

### BRIEF DESCRIPTION OF THE DRAWINGS

FIG. 1 is a schematic diagram of a structure of a quantum chip in a conventional technology.

FIG. 2 is a schematic diagram of a three-dimensional structure of a quantum chip according to an embodiment.

FIG. 3 is a front view of FIG. 2.

FIG. 4 is a schematic diagram of a three-dimensional structure of a substrate in FIG. 2.

FIG. 5 is a front view of FIG. 4.

FIG. 6 is a schematic diagram of a three-dimensional structure of an adapter plate in FIG. 2.

FIG. 7 is a front view of FIG. 6.

FIG. 8 is a schematic structural diagram of a substrate and an adapter plate in FIG. 2.

FIG. 9 is a schematic diagram of a flip-chip bonding structure between a quantum chip and a PCB according to an embodiment.

FIG. 10 is a front view of an adapter plate according to an embodiment.

FIG. 11 is a rear view of FIG. 10.

FIG. 12 is a schematic diagram of a wire bonding three-dimensional structure between a quantum chip and a PCB according to an embodiment.

FIG. 13 is a front view of FIG. 12.

FIG. 14 is a schematic diagram of an enlarged structure of part A in FIG. 13.

FIG. 15 is a cross-sectional view of a through hole and a superconductor on an adapter plate in FIG. 14.

FIG. 16 is a schematic structural diagram of a readout signal port on a substrate according to an embodiment.

FIG. 17 is a schematic structural diagram of a substrate that has a plurality of qubits in a mirror-image arrangement according to an embodiment.

FIG. 18 is a schematic diagram of an improved structure of a substrate that has a plurality of qubits in a mirror-image arrangement according to an embodiment.

FIG. 19 is a schematic structural diagram of a substrate according to an embodiment.

### DETAILED DESCRIPTION OF THE EMBODIMENTS

Embodiments described below with reference to the accompanying drawings are exemplary and merely used to explain the present disclosure, but cannot be understood as a limitation on the present disclosure.

To make the objectives, technical solutions, and advantages of the embodiments of the present application clearer, the following describes the embodiments of the present application in detail with reference to the accompanying drawings. However, a person of ordinary skill in the art may understand that many technical details are put forward in the embodiments of the present application to make a reader better understand the present application. However, the technical solutions claimed in the present application may be implemented even without the technical details and various changes and modifications on a basis of the following embodiments. The division of the following embodiments is for convenience of description, and should not constitute any limitation on the specific implementations of the present application, and various embodiments may be mutually referenced on the premise of no contradiction.

The solution provided in the present application is to solve a problem as follows: a quantum chip in a current superconducting system generally uses a pattern in which a qubit, a read cavity, a microwave line, ports thereof, and other structures are formed on one substrate, as a requirement for computing capability of a quantum computer is improved, a requirement for a large quantity of qubits is increasingly urgent, and it is difficult to implement expansion of a large quantity of qubits according to the foregoing method.

Referring to FIG. 1, FIG. 1 is a schematic structural diagram of a structure of a quantum chip in a conventional technology.

FIG. 1 shows a schematic diagram of a structure of a quantum chip having six qubits 40 and corresponding signal transmission lines 101 on a substrate 10.

As shown in the FIG. 1. The six qubits 40 occupy a small area on a surface of the substrate 10, and most area of the surface structure are occupied by the signal transmission lines 101. In addition, a physical structure of the qubits 40 may limit wiring of the signal transmission lines 101. It may be imagined that when more qubits 40 are integrated on the surface of the substrate 10, integration is extremely difficult due to a size limitation of a chip, and it is difficult to implement quantity expansion of the qubits 40. Through research and experiments of the inventors, a novel quantum chip structure that facilitates quantity extension of the qubits 40 is proposed.

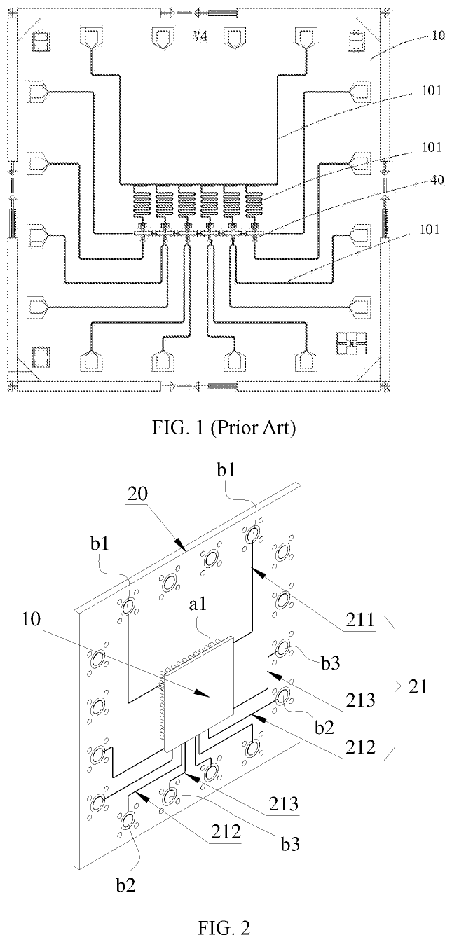

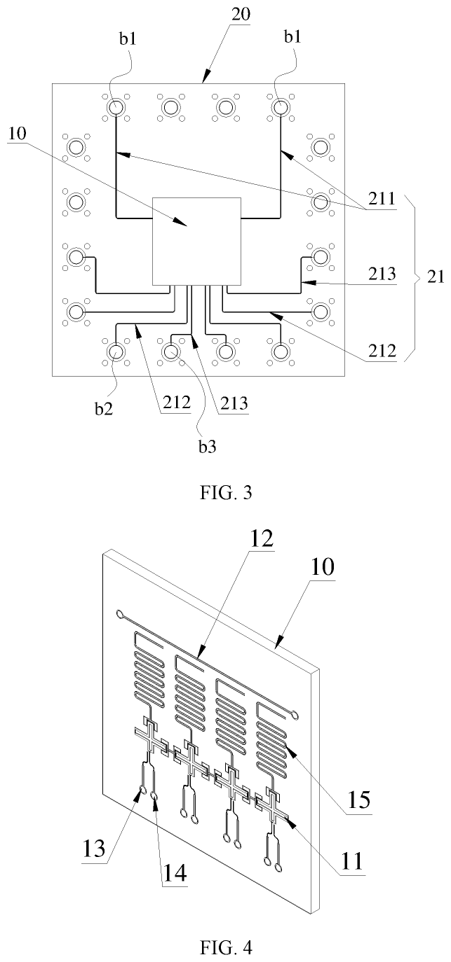

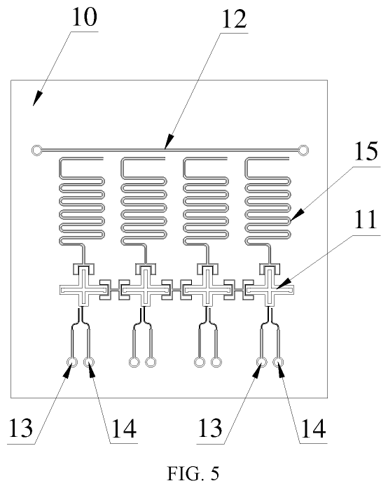

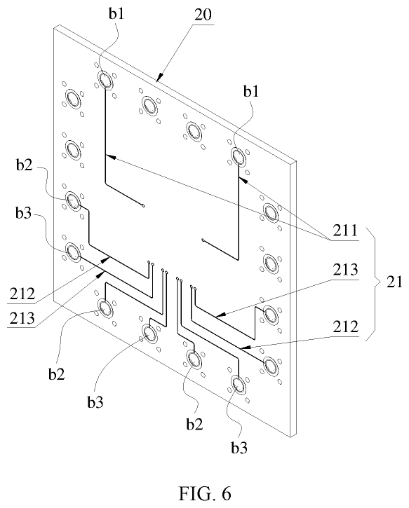

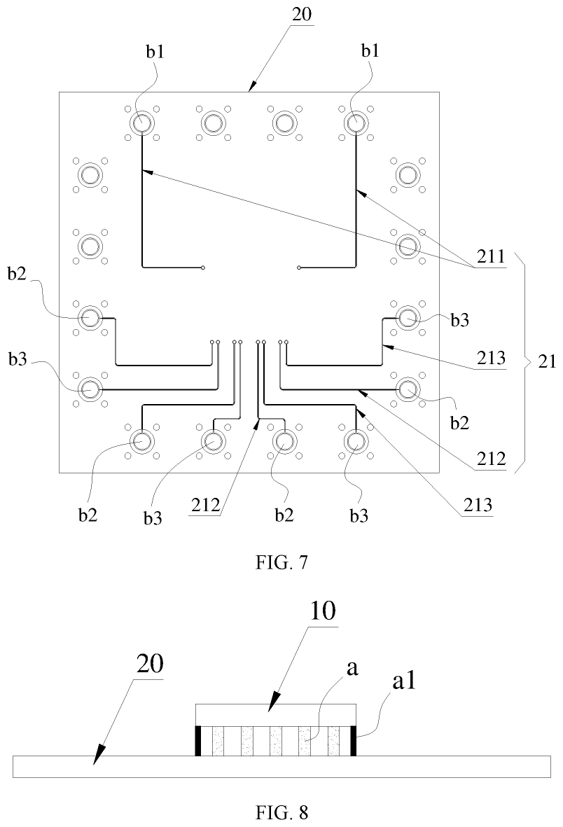

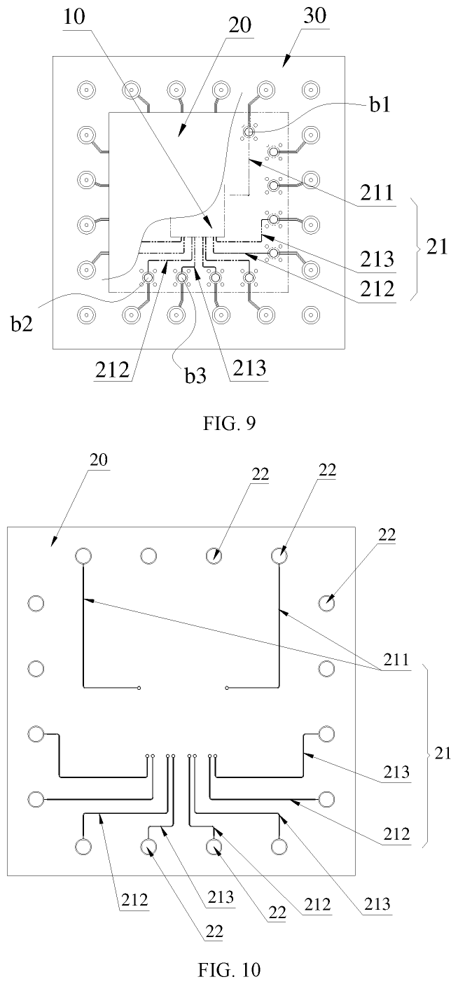

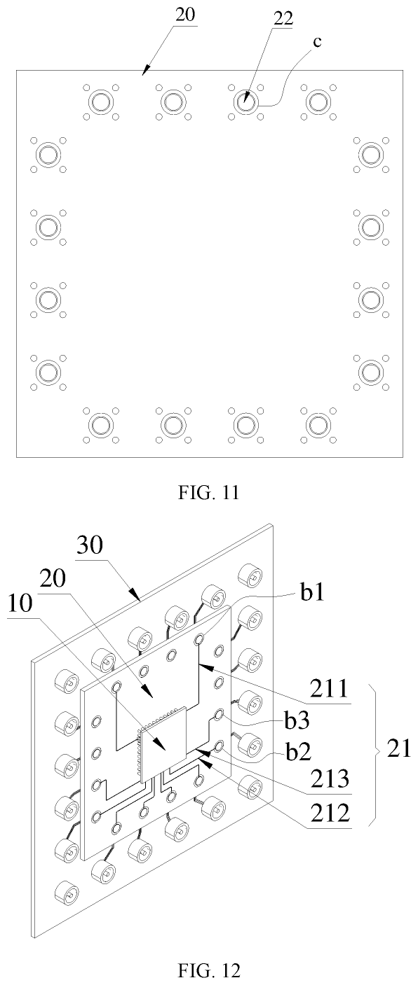

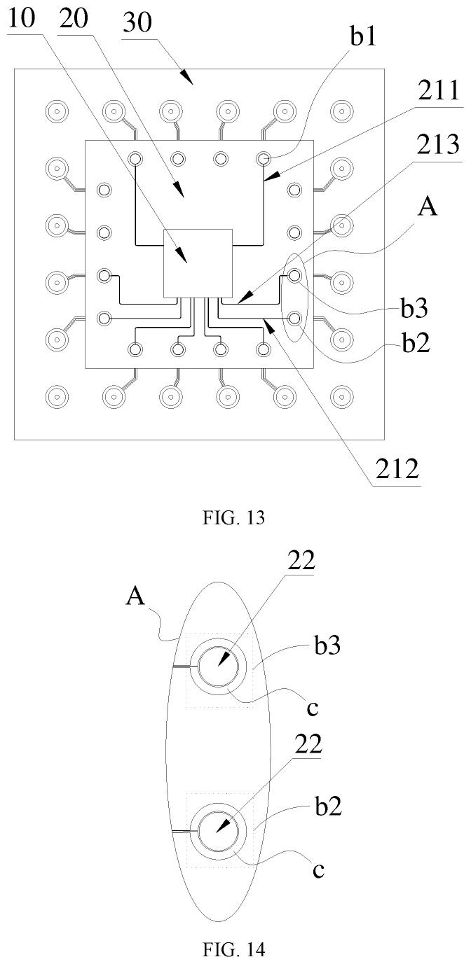

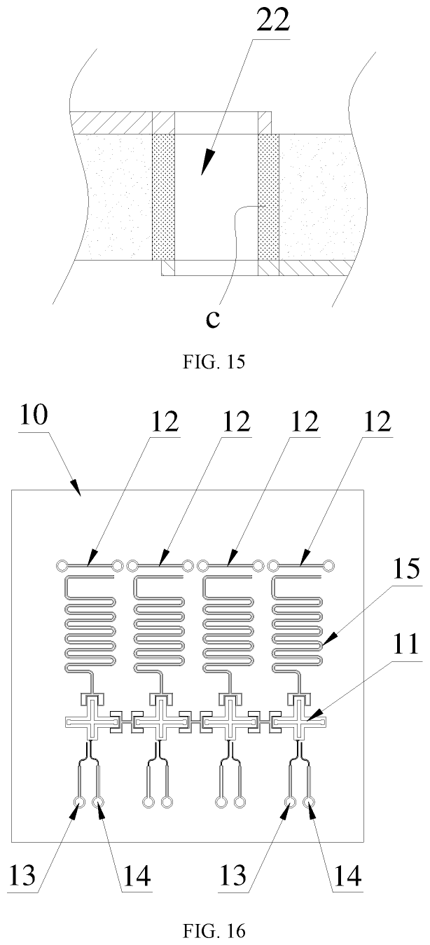

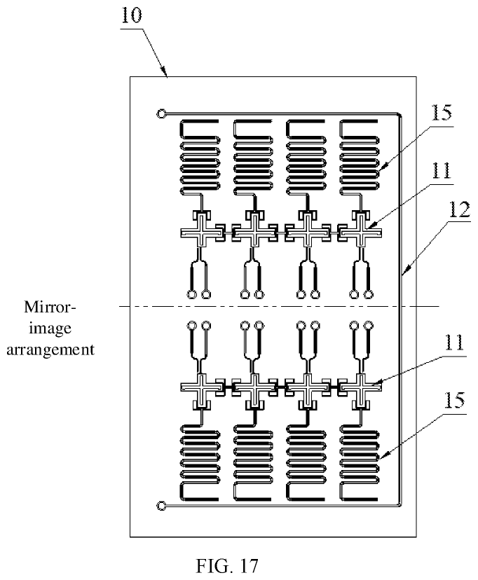

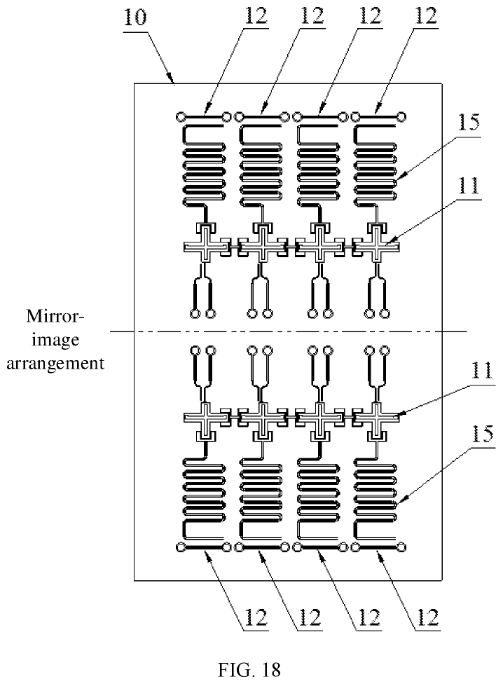

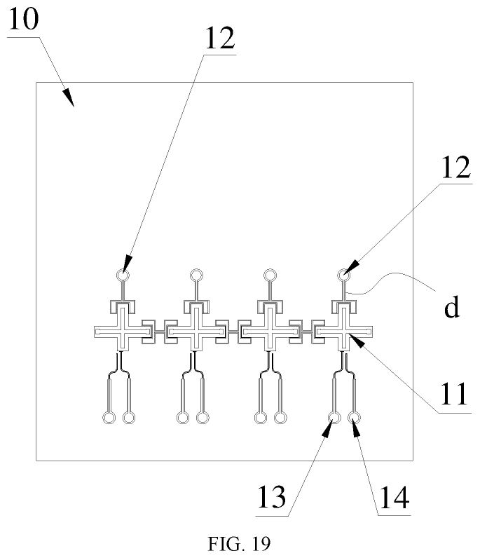

Referring to FIG. 2 to FIG. 19, FIG. 2 is a schematic diagram of a three-dimensional structure of a quantum chip according to an embodiment; FIG. 3 is a front view of FIG. 2; FIG. 4 is a schematic diagram of a three-dimensional structure of a substrate in FIG. 2; FIG. 5 is a front view of FIG. 4; FIG. 6 is a schematic diagram of a three-dimensional structure of an adapter plate in FIG. 2; FIG. 7 is a front view of FIG. 6; FIG. 8 is a schematic structural diagram of a substrate and an adapter plate in FIG. 2; FIG. 9 is a schematic diagram of a flip-chip bonding structure between a quantum chip and a PCB according to an embodiment; FIG. 10 is a front view of an adapter plate according to an embodiment; FIG. 11 is a rear view of FIG. 10; FIG. 12 is a schematic diagram of a wire bonding three-dimensional structure between a quantum chip and a PCB according to an embodiment; FIG. 13 is a front view of FIG. 12; FIG. 14 is a schematic diagram of an enlarged structure of part A in FIG. 13; FIG. 15 is a cross-sectional view of a through hole and a superconductor on an adapter plate in FIG. 14; FIG. 16 is a schematic structural diagram of a readout signal port on a substrate according to an embodiment; FIG. 17 is a schematic structural diagram of a substrate that has a plurality of qubits in a mirror-image arrangement according to an embodiment; FIG. 18 is a schematic diagram of an improved structure of a substrate that has a plurality of qubits in a mirror-image arrangement according to an embodiment; and FIG. 19 is a schematic structural diagram of a substrate according to an embodiment.

As shown in FIG. 2 to FIG. 4, in an embodiment, a quantum chip is provided, and a structure and a fabrication method of the quantum chip are as follows.

The quantum chip includes: a substrate 10, where at least one qubit 11 is formed on the substrate 10; and an adapter plate 20, where signal transmission lines 21 are formed on the adapter plate 20, and the signal transmission lines 21 are electrically connected to the qubit 11.

The substrate 10 may include a substrate in a semiconductor chip field and/or in the superconductor chip field, for example, a sapphire substrate, a silicon substrate, a silicon carbide substrate, and a gallium nitride substrate, and so on. In the present application, a silicon carbide substrate is preferably selected as the substrate 10, so that a formed quantum chip has good thermal conductivity, thereby greatly reducing thermal power consumption during operation of the quantum chip, and further reducing thermal power consumption and thermal radiation in a quantum computing system including the quantum chip.

A material of the adapter plate 20 may be the same as or different from a material of the substrate 10. In this implementation, one of a silicon substrate, a silicon carbide substrate, or a PCB may be selected as the material of the adapter plate 20.

In this embodiment, the signal transmission lines 21 that control the qubit 11 on the substrate 10 are all integrated into the adapter plate 20. The signal transmission lines 21 are separated from the substrate 10, so that area occupation of the substrate 10 can be effectively reduced, and more qubits 11 can be disposed on the substrate 10 of a same size. In addition, a size of the substrate 10 can be greatly reduced when a same quantity of qubits 11, especially thousands or even hundreds of millions of qubits 11, are arranged, thereby reducing a size of a quantum chip that is subsequently formed.

As shown in FIG. 4 and FIG. 5, in this embodiment, a readout signal port 12, an XY signal port 13, and a Z signal port 14 are further formed on the substrate 10. A function of the readout signal port 12 is to read out information of the qubit 11 and provide connection, and also provide an external port. In this embodiment, the XY signal port 13 is connected to the qubit 11 through capacitive coupling, the Z signal port 14 is connected to the qubit 11 through inductive coupling, and the XY signal port 13 and the Z signal port 14 are configured to control the information of the qubit 11 and provide connection, and also provide an external port.

In this embodiment, a microwave resonant cavity 15 coupled to a qubit 11 in a one-to-one correspondence manner is formed on the substrate 10, and the readout signal port 12 is coupled to the microwave resonant cavity 15. In this implementation, the readout signal port 12 is a transmission line that has connection ports at two ends, one of the two connection ports is used for an input of a readout signal, and the other is used for an output of a readout signal. A material of the transmission line is a metal material capable of conducting an electrical signal. In this embodiment, an aluminum metallic wire is used. The readout signal port 12 is coupled to all microwave resonant cavities 15 on the substrate 10 in an inductive coupling manner. The microwave resonant cavity 15 and the qubit 11 are connected in a capacitive coupling manner.

The microwave resonant cavity 15 is connected to the qubit 11 through capacitive coupling, so as to indirectly read out information in the qubit 11; and the readout signal port 12 is connected to the microwave resonant cavity 15 through inductive coupling, so as to indirectly read out a signal in the microwave resonant cavity 15 and transmit the signal to the external, thereby avoiding a case that information in the qubit 11 collapses due to direct readout of information in the qubit 11, and providing a protection function and improving security performance.

As shown in FIG. 6 and FIG. 7, and with reference to FIG. 3 and FIG. 5, in this embodiment, the qubit 11 is connected to the signal transmission lines 21 through the readout signal port 12, the XY signal port 13, and the Z signal port 14, respectively.

The signal transmission lines 21 include a readout signal line 211 electrically connected to the readout signal port 12, an XY signal control line 212 electrically connected to the XY signal port 13, and a Z signal control line 213 electrically connected to the Z signal port 14.

The readout signal line 211 is divided into two parts, where one part is used for an input of a readout signal, and the other is used for an output of a readout signal. The two parts are respectively connected to two connection ports on the readout signal port 12 to form one transmission line.

The XY signal control line 212 controls information of the qubit 11 by using the XY signal port 13, and the Z signal control line 213 controls the information of the qubit 11 by using the Z signal port 14.

As shown in FIG. 8, and with reference to FIG. 3, FIG. 5, and FIG. 6, in this embodiment, an indium pillar a is formed between the readout signal port 12 and the readout signal line 211, between the XY signal port 13 and the XY signal control line 212, and between the Z signal port 14 and the Z signal control line 213, and the indium pillar a is used for implementing electrical connection between the readout signal port 12 and the readout signal line 211, between the XY signal port 13 and the XY signal control line 212, and between the Z signal port 14 and the Z signal control line 213. First, one indium pillar a is fastened to each of the readout signal port 12, the XY signal port 13, and the Z signal port 14, and then the indium pillars a on the readout signal port 12, the XY signal port 13, and the Z signal port 14 are respectively fastened to the readout signal line 211, the XY signal control line 212, and the Z signal control line 213 in a flip-chip bonding manner to implement fastening and connection, so that the substrate 10 is fastened onto the adapter plate 20.

In another embodiment, connection between the readout signal port 12 and the readout signal line 211, between the XY signal port 13 and the XY signal control line 212, and between the Z signal port 14 and the Z signal control line 213 may alternatively be implemented in a bump manner. A metal bump with conductive performance, such as aluminum, copper, gold, or silver, or a superconductor material, such as TiN, is used.

To avoid damage to the indium pillar a or the metal bump after connection, a connecting pillar al for fastening is disposed between the substrate 10 and the adapter plate 20. Two ends of the connecting pillar al are respectively fastened to the substrate 10 and the adapter plate 20. Thus, stability of the substrate 10 on the adapter plate 20 is improved, to prevent an open circuit due to damage to the indium pillar a or the metal bump because of micro displacement of the substrate 10 on the adapter plate 20 due to an external force, thereby reducing a defective rate and improving quality.

In an operation process, another embodiment is as follows: A penetrating through hole is disposed on a substrate, and a metal piece is formed in the through hole. Two ends of the metal piece are electrically connected to a qubit and a signal transmission line on an adapter plate, respectively.

This method can only be used on a substrate with a small quantity of qubits, such as a few or dozens of qubits. However, if there are more than hundreds or thousands or even tens of thousands of qubits, a quantity of through holes that cooperate with the large quantity of qubits will be multiplied due to a size and thickness limitation of the substrate, thereby greatly weakening a strength of the substrate. Thus, the substrate is easily broken or fragmented, and damage to the qubit is easily caused, making subsequent processes impossible and causing a high damage rate.

Therefore, when an indium pillar a is used for connection, the foregoing technical problems can be solved, and the process difficulty is greatly reduced.

According to the foregoing analysis, in another embodiment, manners of using an indium pillar a for connection and providing a penetrating through hole in the substrate 10 with a metal piece formed in the through hole may be combined to electrically connect the readout signal port 12 to the readout signal line 211, the XY signal port 13 to the XY signal control line 212, and the Z signal port 14 to the Z signal control line 213. In this manner, a design of a multi-layer adapter plate 20 can be implemented. For example (not shown in the structural diagram), an adapter plate is designed on each of a front surface and a back surface of a substrate. The substrate and the adapter plate disposed on the front surface of the substrate are connected by using an indium pillar a, to implement connection of the lines, and the substrate and the adapter plate disposed on the back surface of the substrate are connected by providing a penetrating through hole in the substrate with a metal piece formed in the through hole, to implement connection of the lines, so that a maximum extension of external wiring lines of qubits can be implemented.

As shown in FIG. 6, FIG. 7, and FIG. 9, and with reference to FIG. 3, in this embodiment, the readout signal line 211 has a first transmission port b1 electrically connected to the readout signal line 211, the XY signal control line 212 has a second transmission port b2 electrically connected to the XY signal control line 212, and the Z signal control line 213 has a third transmission port b3 electrically connected to the Z signal control line 213. The readout signal line 211, the XY signal control line 212, the Z signal control line 213, the first transmission port b1, the second transmission port b2, and the third transmission port b3 are located on a same surface of the adapter plate 20, and the first transmission port b1, the second transmission port b2, and the third transmission port b3 are all fastened onto the adapter plate 20.

The adapter plate 20 is installed on an external PCB 30 in a flip-chip bonding manner, and the first transmission port b1, the second transmission port b2, and the third transmission port b3 on the adapter plate 20 are electrically connected to lines on the PCB 30, as shown in the perspective part in FIG. 9.

In this manner, a function of hiding the substrate 10 can be implemented, and the substrate 10 is located between the adapter plate 20 and the PCB 30, so that a function of protecting the substrate 10 and a component on the substrate 10 can be implemented.

In another embodiment, a through hole or a groove matching the substrate 10 is disposed at a position, corresponding to the substrate 10, on the PCB 30, so that the substrate 10 can be accommodated when flip-chip bonding is used.

As shown in FIG. 10 to FIG. 15, and with reference to FIG. 4, in another embodiment, the readout signal line 211, the XY signal control line 212, and the Z signal control line 213 are located on a first surface of the adapter plate 20, the first transmission port b1, the second transmission port b2, and the third transmission port b3 are located on a second surface of the adapter plate 20, and the first surface and the second surface are two opposite surfaces of the adapter plate 20, namely, a front surface and a back surface of the adapter plate 20. A plurality of through holes 22 are formed on the adapter plate 20, and a through hole 22 is provided at each of the first transmission port b1, the second transmission port b2, and the third transmission port b3. A superconductor c is formed in the through hole 22, and a forming manner of the superconductor c in the through hole 22 is one of physical vapor deposition, chemical vapor deposition, 3D printing, or electrochemical plating.

A structure of the superconductor c may be columnar, or may be a bucket-like structure with a specific thickness plated on an inner wall of the through hole 22. As shown in FIG. 15, the superconductor c is a bucket-like structure, and the columnar structure is not shown in the accompanying drawings.

For example, a material of the superconductor c is TiN.

The readout signal line 211, the XY signal control line 212, and the Z signal control line 213 are in a one-to-one correspondence with and connected by using a superconductor c to the first transmission port b1, the second transmission port b2, and the third transmission port b3, respectively.

The adapter plate 20 is installed on an external PCB 30 in a wire bonding manner, and as shown in FIG. 12 and FIG. 13, the first transmission port b1, the second transmission port b2, and the third transmission port b3 on the adapter plate 20 are electrically connected to lines on the PCB 30.

In this manner, the substrate 10 is not located between the adapter plate 20 and the PCB 30, so that heat dissipation performance of the substrate 10 and a component on the substrate 10 can be improved.

As shown in FIG. 16, in another implementation, a quantity of readout signal ports 12 is the same as a quantity of qubits 11, and the readout signal ports 12 are coupled to the at least one qubit 11 in a one-to-one correspondence manner.

Specifically, each readout signal port 12 is correspondingly coupled to a corresponding qubit 11 by using a microwave resonant cavity 15, and each readout signal port 12 is a transmission line that has a connection port at both ends. A plurality of connection lines (not shown in the figure) are designed on the adapter plate, and a plurality of readout signal ports 12 are connected in series from end to end by using the plurality of connection lines, to form an entire transmission line, thereby reducing occupied space of the substrate 10.

This design structure has an obvious effect on a substrate with a plurality of qubits. As shown in FIG. 17, the substrate 10 has a plurality of qubits 11 in a mirror-image arrangement. When one readout signal port 12 is used, a transmission line between two connection ports of the readout signal port 12 needs to be arranged in a large span, occupying a large space of the substrates 10.

When a structure of a plurality of readout signal ports 12 in FIG. 16 is used, an effect is very obvious.

As shown in FIG. 18, a substrate 10 that has a plurality of qubits in a mirror-image arrangement uses a plurality of readout signal ports 12, and each readout signal port 12 is a transmission line that has a connection port at both ends. A plurality of connection lines (not shown in the figure) are designed on an adapter plate, and a plurality of readout signal ports 12 are connected in series from end to end by using the plurality of connection lines, to form an entire transmission line. In this way, on a structure of the substrate 10 that has a plurality of qubits in a mirror-image arrangement, space occupancy of the substrate 10 can be greatly reduced, and a quantity of qubits 11 on the substrate 10 can be increased.

In another embodiment, structures on the adapter plate 20 may be directly designed on the PCB 30. A signal transmission line 21 on the adapter plate 20 is directly connected to a control line on the PCB 30, and a structure such as a through hole 22 does not need to be designed, which reduces a process difficulty, reduces production costs, and improves production efficiency.

As shown in FIG. 19, and with reference to FIG. 5, FIG. 7, and FIG. 10, in another embodiment, a readout signal port 12 formed on a substrate 10 is connected to a qubit 11 through capacitive coupling. Specifically, the readout signal port 12 is arranged on the substrate 10, and a coupling transmission line d is formed between the readout signal port 12 and the qubit 11. One end of the coupling transmission line d is connected to the readout signal port 12, and the other end of the coupling transmission line d is connected to the qubit 11 through capacitive coupling.

A microwave resonant cavity 15 connected to the readout signal port 12 is directly disposed on the adapter plate 20 (not shown in the structural diagram), and the microwave resonant cavity is directly coupled to the signal transmission line 21 on the adapter plate 20. Therefore, occupied space on the substrate 10 can be further reduced, and an expansion amount of qubits 11 on the substrate 10 can be further increased.

Further, all structures on the adapter plate 20 may be directly designed on the PCB 30. A signal transmission line 21 on the adapter plate 20 is directly connected to a control line on the PCB 30, and a structure such as a through hole 22 does not need to be designed, which reduces a process difficulty, reduces production costs, and improves production efficiency.

An embodiment further provides a quantum computer, where the quantum computer includes the quantum chip provided in any one of the foregoing implementations, and has beneficial effects of the quantum chip provided in the corresponding embodiment, and does not exclude combinable beneficial effects.

In conclusion, beneficial effects of the embodiments include but are not limited to the following effects.

Firstly, as a quantity of qubits increases, if structures such as a qubit, a readout signal line, an XY signal control line, and a Z signal control line are integrated into one substrate in a conventional manner, it is difficult to implement fabrication of large-scale qubits. A large quantity of signal transmission lines that occupy an area of the substrate are independently arranged, an adapter plate is disposed, signal transmission lines such as a readout signal line, an XY signal control line, and a Z signal control line are disposed on the adapter plate, and only a readout signal port, an XY signal port, and a Z signal port that are correspondingly connected to a qubit are fabricated on the substrate. The readout signal port, the XY signal port, and the Z signal port are respectively connected to the readout signal line, the XY signal control line, and the Z signal control line. In this way, more space is reserved on the substrate for fabrication of qubits, thereby greatly reducing an occupation area on the substrate. Therefore, more qubits can be fabricated on a substrate of a same area, improving integration.

Secondly, signal transmission lines are disposed on an adapter plate and are separated from a substrate. During packaging, the signal transmission lines are distributed on the adapter plate in a diffusion manner, and not concentrated on the substrate, facilitating an electrical connection between the signal transmission lines and an external PCB.

Thirdly, a quantum computer is further provided, which has a corresponding beneficial effect brought by the quantum chip provided in any one of the foregoing embodiments, and combinable beneficial effects are not excluded.

Lastly, a fabrication method for a quantum chip is further provided. In a corresponding embodiment, the quantum chip fabricated by using the method has beneficial effects of the quantum chip in the corresponding embodiment.

The constructions, features and functions of various embodiments are described in detail in the embodiments illustrated with reference to the accompanying drawings. The foregoing is merely preferred embodiments. The implementation scope shall not be limited by the content shown in the accompanying drawings. All equivalent embodiments that are changed or modified according to the concept herein and do not depart from the spirit of the description and the drawings should fall within the protection scope of the present application.

What is claimed is:

1. A quantum chip, comprising:
a substrate, on which at least one qubit is formed; and
an adapter plate, wherein signal transmission lines are formed on the adapter plate, and the signal transmission lines are electrically connected to the at least one qubit;
wherein a readout signal port is further formed on the substrate, a quantity of readout signal ports is the same as a quantity of qubits, and the readout signal ports are coupled to the at least one qubit in a one-to-one correspondence manner, each readout signal port is a transmission line that has connection ports at two ends;
wherein the signal transmission lines comprise a readout signal line electrically connected to the readout signal ports, and the readout signal line is formed by a plurality of connection lines, a plurality of readout signal ports are connected in series from end to end by using the plurality of connection lines, to form an entire transmission line.

2. The quantum chip according to claim 1, wherein an XY signal port, and a Z signal port are further formed on the substrate;
the signal transmission lines further comprise an XY signal control line and a Z signal control line; and
the at least one qubit is connected to the XY signal control line and the Z signal control line respectively through the XY signal port and the Z signal port.

3. The quantum chip according to claim 2, wherein a microwave resonant cavity coupled to the at least one qubit in a one-to-one correspondence manner is further formed on the substrate, and each readout signal port is coupled to a corresponding qubit through a corresponding microwave resonant cavity.

4. The quantum chip according to claim 2, wherein an indium pillar or a metal bump for implementing electrical connection is formed between the readout signal ports and the readout signal line, between the XY signal port and the XY signal control line, and between the Z signal port and the Z signal control line.

5. The quantum chip according to claim 2, wherein the readout signal line has a first transmission port, the XY signal control line has a second transmission port, and the Z signal control line has a third transmission port.

6. The quantum chip according to claim 5, wherein the readout signal line, the XY signal control line, the Z signal control line, the first transmission port, the second transmission port, and the third transmission port are located on a same surface of the adapter plate.

7. The quantum chip according to claim 5, wherein the readout signal line, the XY signal control line, and the Z signal control line are located on a first surface of the adapter plate, and the first transmission port, the second transmission port, and the third transmission port are located on a second surface of the adapter plate.

8. The quantum chip according to claim 7, wherein a plurality of through holes are formed on the adapter plate, and a superconductor is disposed in each of the through holes;
a through hole is provided at each of the first transmission port, the second transmission port, and the third transmission port; and
the readout signal line, the XY signal control line, and the Z signal control line are in a one-to-one correspondence with and connected by using the superconductor to the first transmission port, the second transmission port, and the third transmission port, respectively.

9. The quantum chip according to claim 5, wherein the substrate is disposed on the adapter plate, and the adapter plate is installed on an external printed circuit board (PCB) in a flip-chip bonding manner or a wire bonding manner, and the first transmission port, the second transmission port, and the third transmission port on the adapter plate are electrically connected to lines on the PCB.

10. The quantum chip according to claim 2, wherein the XY signal port is connected to the at least one qubit through capacitive coupling.

11. The quantum chip according to claim 2, wherein the Z signal port is connected to the at least one qubit through inductive coupling.

12. The quantum chip according to claim 2, wherein a through hole is disposed on the substrate, and a metal piece is formed in the through hole, and the metal piece is used to complete electrical connection between the readout signal ports and the readout signal line, between the XY signal port and the XY signal control line, and between the Z signal port to the Z signal control line, respectively.

13. The quantum chip according to claim 2, wherein there are two adapter plates, one adapter plate is disposed on a front surface of the substrate, the other adapter plate is disposed on a back surface of the substrate; a readout signal line, an XY signal control line and a Z signal control line on the adapter plate disposed on a front surface of the substrate are respectively electrically connected to a readout signal port, an XY signal control line and a Z signal port on the substrate though an indium pillar or a metal bump; a readout signal line, an XY signal control line and a Z signal control line on the adapter plate disposed on a back surface of the substrate are respectively electrically connected to a readout signal port, an XY signal control line and a Z signal port on the substrate though a metal piece disposed in a through hole disposed on the substrate.

14. The quantum chip according to claim 13, wherein the at least one qubit, the readout signal ports, the XY signal port and the Z signal port are disposed on the front surface of the substrate.

15. The quantum chip according to claim 1, wherein a connecting pillar is disposed between the substrate and the adapter plate, two ends of the connecting pillar are respectively fastened to the substrate and the adapter plate, and the connecting pillar is used to prevent a micro displacement of the substrate on the adapter plate.

16. The quantum chip according to claim 1, wherein the at least one qubit on the substrate is divided into two groups and the two groups of qubits are arranged in mirror image.

17. The quantum chip according to claim 9, wherein a through hole or a groove matching the substrate is disposed at a position, corresponding to the substrate, on the PCB, the substrate can be accommodated in the through hole or the groove when the adapter plate is installed on the PCB in a flip-chip bonding manner.

18. The quantum chip according to claim 3, wherein each readout signal port is coupled to corresponding microwave resonant cavities in an inductive coupling manner, each microwave resonant cavity is coupled to corresponding qubit in a capacitive coupling manner.

19. A quantum computer, comprising a quantum chip, wherein the quantum chip comprises:
a substrate, on which at least one qubit is formed; and
an adapter plate, wherein signal transmission lines are formed on the adapter plate, and the signal transmission lines are electrically connected to the at least one qubit;
wherein a readout signal port is further formed on the substrate, a quantity of readout signal ports is the same as a quantity of qubits, and the readout signal ports are coupled to the at least one qubit in a one-to-one correspondence manner, each readout signal port is a transmission line that has connection ports at two ends;
wherein the signal transmission lines comprise a readout signal line electrically connected to the readout signal ports, and the readout signal line is formed by a plurality of connection lines, a plurality of readout signal ports are connected in series from end to end by using the plurality of connection lines, to form an entire transmission line.

20. A fabrication method for a quantum chip, comprising:
providing a substrate, and forming at least one qubit and a readout signal port on the substrate, a quantity of readout signal ports is the same as a quantity of qubits, and the readout signal ports are coupled to the at least one qubit in a one-to-one correspondence manner, each readout signal port is a transmission line that has connection ports at two ends; and
further providing an adapter plate, and forming signal transmission lines on the adapter plate, and the signal transmission lines are electrically connected to the at least one qubit;
wherein the signal transmission lines comprise a readout signal line electrically connected to the readout signal ports, and the readout signal line is formed by a plurality of connection lines, a plurality of readout signal ports are connected in series from end to end by using the plurality of connection lines, to form an entire transmission line.
